(19) United States
(12) Patent Application Publication
(10) Pub. No.: US 2016/0180994 A1
(43) Pub. Date: Jun. 23, 2016

(54) METHOD OF MANUFACTURING SOFT MAGNETIC MATERIAL

(71) Applicant: METAL INDUSTRIES RESEARCH & DEVELOPMENT CENTRE, Kaohsiung City (TW)

(72) Inventors: Che-Nan Kuo, Kaohsiung City (TW); De-Chang Tsai, Kaohsiung City (TW); Ho-Chung Fu, Kaohsiung City (TW); Ying-Cheng Lu, Kaohsiung City (TW); Chun-Lin Yeh, Tainan City (TW); Meng-Hsiu Tsai, Kaohsiung City (TW)

(21) Appl. No.: 14/577,771

(22) Filed: Dec. 19, 2014

(51) Int. Cl. H01F 1/153; B22F 3/105; C22C 1/00; B23K 26/00; C22C 45/00; H01F 41/02; B23K 15/00; B23K 26/342; B22F 9/04; C22C 1/02

(52) U.S. Cl. CPC H01F 1/15341; B22F 9/04; B22F 3/1055; C22C 1/002; C22C 1/02; C22C 45/008; H01F 1/15308; H01F 1/15316; H01F 41/02; B23K 15/0086; B23K 15/0093; B23K 26/342; B23K 26/0006; B33Y 10/00

(57) ABSTRACT

A method of manufacturing soft magnetic material, including smelting magnetic and metallic glass forming compositions, to form a uniform molten master alloy block material, melting the master alloy material into liquid, and exerting a force on the liquid master alloy block material to make it into coarse powder. The coarse powder is screened to separate the working powder, and the working powder is put into an additive manufacturing device, to make the working powder melt, cool and condense into the soft magnetic material. The soft magnetic material is made by a simple process, with low iron loss rate and better electromagnetic shielding feature and other properties, and can improve magnetic permeability and save energy when applied to the electronic products.

### BACKGROUND OF THE INVENTION

1. Field of the Invention

The present invention is a method of manufacturing material, especially soft magnetic material.

2. Brief Description of the Prior Art

With the progress of science and technology and the popularity of nano technology, many kinds of large volume, stationary electronic products have been gradually reduced to portable electronic products, including the internal components of electronic equipments. The core materials, rotors, stators and other components of the electronic products are mostly made of silicon steel sheet. Silicon steel sheet has the advantages of easy processing and low cost, but it needs more processes to meet demand due to its characteristics. For example, during usage, the temperature of the silicon steel sheet will easily rise to cause iron loss and poor electromagnetic conversion rate. As such, the pioneers of the field have developed related soft magnetic composite materials to replace silicon steel sheet. However, due to the limitation of the metallic glass forming ability (GFA) and foundry technology, most of the soft magnetic composite materials cannot achieve mass production or form large scale or complex shapes. Therefore, developing a kind of highly efficient, soft magnetic materials with high strength, high elasticity, abrasion resistance, corrosion resistance, soft magnetic, magnetic conductivity, and magnetic connectivity, has always been the goal of multiple efforts.

### SUMMARY OF THE INVENTION

The main purpose of the present invention is to provide a method of manufacturing soft magnetic material, which is a kind of amorphous soft magnetic material with one-step forming and excellent magnetic properties, and which can reduce the energy loss caused by the electromagnetic conversion process.

The present invention provides a method of manufacturing soft magnetic material, including: smelting magnetic composition and metallic glass forming composition, to form the uniform molten master alloy block material; melting the master alloy material into liquid, and exerting a force on the liquid master alloy block material to make it into coarse powder; screening the coarse powder to separate the working powder; and, finally, putting the working powder into an additive manufacturing device, and making the working powder melt, cool and condense into the soft magnetic material. The soft magnetic material has the non-crystalline and non-directional properties of metallic glass.

The magnetic composition is iron, cobalt or nickel. The metallic glass forming composition is phosphorus, boron, molybdenum, niobium, zirconium silicon, or carbon. The master alloy block material is smelted from iron, cobalt or nickel (one or more compositions) and phosphorus, boron, silicon, carbon, niobium, zirconium or molybdenum (one or more compositions).

The additive manufacturing device contains a work unit and a thermal management unit. The work unit can provide beam power and beam melting time to melt, cool and condense the working powder. Also, during melting, cooling and condensing the working powder, the thermal management unit can control the beam power and the beam melting time provided by the work unit. The thermal management unit contains a special water cooling platform and a real-time temperature monitoring feedback module. The real-time temperature monitoring feedback module can send messages to the work unit and the special water cooling platform, to adjust the beam power and the beam melting time provided by the work unit. The special water cooling platform can control the cooling and condensation rate of the working powder.

While melting the master alloy block material and exerting a force on it, if the force is a fluid impact force, the molten master alloy block material can be cut into the liquid microspheres by the fluid impact force, and the liquid microspheres can form the coarse powder by cooling and condensation. If the force is a rotating centrifugal force, the molten master alloy block material can be dispersed and aggregated into the liquid microspheres by the rotating centrifugal force, and the liquid microspheres can form the coarse powder by cooling and condensation.

During screening, the coarse powder, the fine powder with a variety of particle size ranges can be gradually separated from the coarse powder by the centrifugal force, and the fine powder (at least including two particle size ranges) will be mixed into the working powder.

When using the laser additive manufacturing device, the particle size range of the working powder is 15 to 45 microns. When using the electron beam additive manufacturing device, the particle size range of the working powder is 45 to 105 microns.

Compared with other techniques, this method of manufacturing soft magnetic material has the following advantages:

1. This soft magnetic material can replace silicon steel sheet to be the iron core of electronic products, and its manufacturing process is simpler than that of silicon steel sheet.

2. This soft magnetic material has low temperature rising rate (low iron loss), can further improve the magnetic permeability, and can save energy.

3. The electromagnetic shielding properties of soft magnetic material is better than that of silicon steel sheet, and can make electronic products more stable in operation and not affected by electromagnetic effect.

### BRIEF DESCRIPTION OF THE DRAWINGS

FIG. 1 is a flow chart of the soft magnetic material manufacturing method.

FIG. 2 is a flow chart of the soft magnetic material manufacturing method.

FIG. 3 is a flow chart of the soft magnetic material manufacturing method.

FIG. 4 is a flow chart of the soft magnetic material manufacturing method.

### MAIN COMPONENT SYMBOL

S101˜S104 Step process
S201˜S204 Step process
S301˜S304 Step process
S301˜S304 Step process

### DETAILED DESCRIPTION OF THE PREFERRED EMBODIMENT

The present invention provides a method of manufacturing soft magnetic material, which is a kind of amorphous soft magnetic material with one-step forming and can be enough to replace the traditional core material. The method includes smelting magnetic composition and metallic glass forming composition, to form the uniform molten master alloy block material. The magnetic composition is iron, cobalt or nickel. The metallic glass forming composition is phosphorus, boron, molybdenum, niobium, zirconium silicon, or carbon. In particular, the master alloy block material is smelted from iron, cobalt or nickel (one or more compositions) and phosphorus, boron, silicon, carbon, niobium, zirconium or molybdenum (one or more compositions). Therefore, the resulting high iron content can maintain the magnetic flux of the master alloy block material. Adding cobalt, nickel or other magnetic materials can increase the deflection, and adding phosphorus, boron, silicon, carbon, niobium, zirconium or molybdenum can even improve the metallic glass forming ability.

Then, the master alloy material is melted into liquid, and a force is exerted on the liquid master alloy block material to make it into coarse powder. If the force is a fluid impact force with gas atomization or water atomization source, the molten master alloy block material can be cut into the liquid microspheres by the fluid impact force, and the liquid microspheres can form the coarse powder by cooling and condensation. If the force is rotating centrifugal force with rotating electrode source, the molten master alloy block material can be dispersed and aggregated into the liquid microspheres by the rotating centrifugal force, the liquid microspheres can form the coarse powder by cooling and condensation.

Then, the coarse powder is screened, the fine powder with a variety of particle size ranges can be gradually separated from the coarse powder by the centrifugal force, and the fine powder (at least including two particle size ranges) will be mixed into the working powder. The working powder with a particle size of 45 to 105 microns has the better forming ability. The centrifugal filter with different mesh sieve can screen the better working powder. Therefore, the different particle size distribution can make up the working powder forming gap, thus significantly improving the quality of the formed material.

Finally, the working powder is put into an additive manufacturing device, making the working powder melt, cool and condense into the soft magnetic material. Specifically, during the manufacturing process with the additive manufacturing device, the molten working powder can maintain a certain cooling rate. Therefore, the final formed soft magnetic material has the non-crystalline and non-directional properties of metallic glass, and can replace the traditional core material, to reduce energy consumption and improve energy utilization rate. The additive manufacturing device can be chosen according to the different powder particle size. For example, the laser additive manufacturing device is suitable for 15 to 45 microns of working powder, and the electron beam additive manufacturing device is suitable for 45 to 105 microns of working powder.

Specifically, the selective laser melting (SLM) device can make the laser with enough power provided by the work unit to hit the working powder to be cured according to the forming scanning time and the sequence, to sinter the material. The electron beam melting (EBM) device can make the electron beam provided by the work unit to hit the working powder to be melted according to the forming scanning time and the sequence, to form the material layer upon layer. Because the traditional additive manufacturing device will generate heat in the process of manufacturing, to influence forming properties of soft magnetic material, this additive manufacturing device therefore contains a work unit and a thermal management unit. The thermal management unit can control the beam power and the beam melting time provided by the work unit. As a result, during melting, cooling and condensation, the working powder can maintain enough cooling rate to form the amorphous soft magnetic material.

The thermal management unit contains a special water cooling platform and a real-time temperature monitoring feedback module. The real-time temperature monitoring feedback module can send messages to the work unit and the special water cooling platform, to adjust the beam power and the beam melting time provided by the work unit. The special water cooling platform can control the cooling and condensation rate of the working powder. The additive manufacturing device can generate high heat during the process. However, the special water cooling platform and the real-time temperature monitoring feedback module can achieve a higher cooling rate to offset the heat generated by the process, so as to avoid affecting the soft magnetic material forming structure or its features, improve the non-crystalline and non-directional properties, and increase the applications of material.

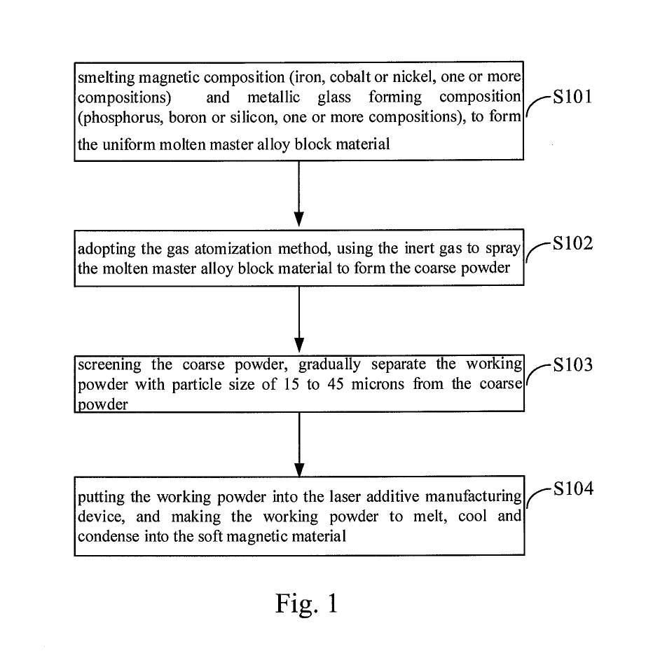

For example, based on the foregoing technology category, the invention can use different ways to manufacture soft magnetic materials. The following instructions apply only to the processes as shown in FIG. 1-4.

With reference to FIG. 1, after manufacturing the master alloy, the fluid impact force and the laser additive manufacturing device are used to form the soft magnetic material, the steps for which are as follows:

S101: smelting iron, cobalt or nickel (one or more compositions) and phosphorus, boron, silicon, carbon, niobium, zirconium or molybdenum (one or more compositions), to form the uniform molten master alloy block material;

S102: adopting the gas atomization method, using the expanding gas produced by the high-pressure nozzle to cut the molten master alloy block material into liquid microspheres, which can form the coarse powder after cooling, and the expanding gas can be the air, inert gas argon, nitrogen and other gases;

S103: screening the coarse powder, and gradually separate the working powder with particle size of 15 to 45 microns from the coarse powder; and

S104: putting the working powder into the laser additive manufacturing device, and making the working powder melt, cool and condense into the soft magnetic material.

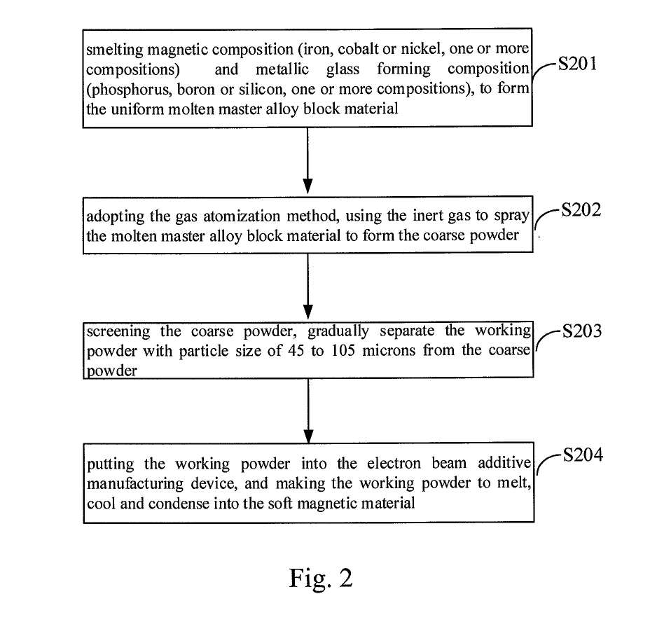

With reference to FIG. 2, after manufacturing the master alloy, the fluid impact force and the electron beam additive manufacturing device are used to form the soft magnetic material, the steps for which are as follows:

S201: smelting iron, cobalt or nickel (one or more compositions) and phosphorus, boron, silicon, carbon, niobium, zirconium or molybdenum (one or more compositions), to form the uniform molten master alloy block material;

S202: adopting the gas atomization method, using the expanding gas produced by the high-pressure nozzle to cut the molten master alloy block material into liquid microspheres, which can form the coarse powder after cooling, and the expanding gas can be the air, inert gas argon, nitrogen and other gases;

S203: screening the coarse powder, and gradually separate the working powder with particle size of 45 to 105 microns from the coarse powder; and

S204: putting the working powder into the electron beam additive manufacturing device, and making the working powder melt, cool and condense into the soft magnetic material.

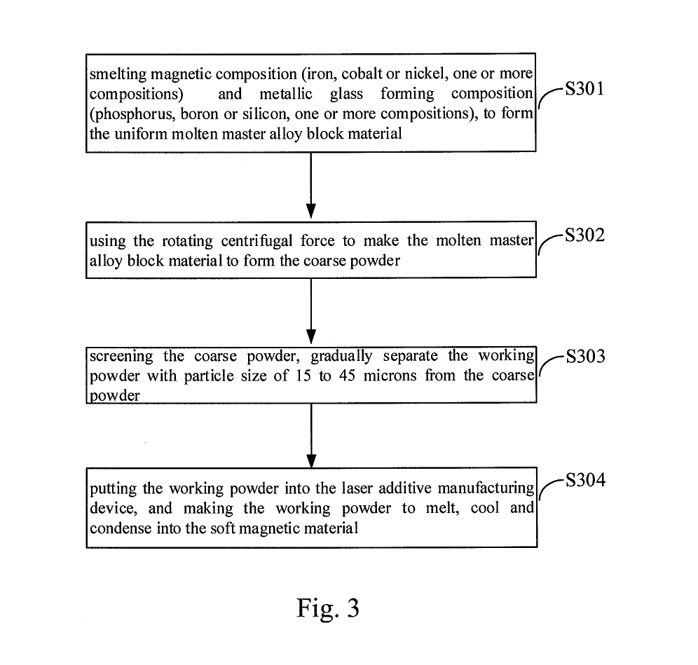

With reference to FIG. 3, after manufacturing the master alloy, the rotating centrifugal force and the laser additive manufacturing device are used to form the soft magnetic material, the steps for which are as follows:

S301: smelting iron, cobalt or nickel (one or more compositions) and phosphorus, boron, silicon, carbon, niobium, zirconium or molybdenum (one or more compositions), to form the uniform molten master alloy block material;

S302: adopting the rotating electrode method, the molten master alloy block material can be dispersed and aggregated into the liquid microspheres during the high-speed centrifugation, and the liquid microspheres can form the coarse powder by cooling and condensation;

S303: screening the coarse powder, gradually separate the working powder with particle size of 15 to 45 microns from the coarse powder; and

S304: putting the working powder into the laser additive manufacturing device, and making the working powder melt, cool and condense into the soft magnetic material.

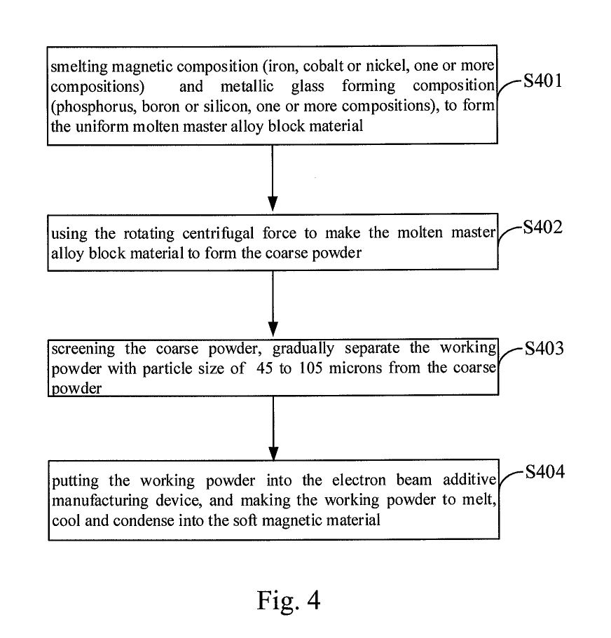

With reference to FIG. 4, after manufacturing the master alloy, the rotating centrifugal force and the electron beam additive manufacturing device are used to form the soft magnetic material, the steps for which are as follows:

S401: smelting iron, cobalt or nickel (one or more compositions) and phosphorus, boron, silicon, carbon, niobium, zirconium or molybdenum (one or more compositions), to form the uniform molten master alloy block material;

S402: adopting the rotating electrode method, the molten master alloy block material can be dispersed and aggregated into the liquid microspheres during the high-speed centrifugation, and the liquid microspheres can form the coarse powder by cooling and condensation;

S403: screening the coarse powder, gradually separate the working powder with particle size of 45 to 105 microns from the coarse powder; and

S404: putting the working powder into the electron beam additive manufacturing device, and making the working powder melt, cool and condense into the soft magnetic material.

In summary, unlike the traditional crystalline materials made by the traditional additive manufacturing method, the soft magnetic material made by the present invention method has the non-crystalline and non-directional properties of metallic glass. Therefore, the soft magnetic material has a short-range order atomic structure, and the number of atoms within a single sector is far less than that of the traditional soft magnetic crystalline materials. Compared with the traditional soft magnetic crystalline materials, the soft magnetic material has higher magnetic conductivity in low magnetic field, quicker sector response rate, low energy consumption during the transformation of the sector direction, and other characteristics. Therefore, if the soft magnetic material made by the present invention method can be used in the magnetic field with different frequencies, it can still maintain the high magnetic permeability, low iron loss and other functions, and is an excellent soft magnetic material.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method of manufacturing soft magnetic material, including:
smelting a magnetic composition and a metallic glass forming composition, to form a uniform molten master alloy block material;
melting the master alloy block material into liquid, and exerting a force on the liquid master alloy block material to make it into a coarse powder;
screening the coarse powder to separate a working powder;
putting the working powder into an additive manufacturing device, and making the working powder melt, cool and condense into the soft magnetic material.

2. The method of claim 1, wherein the magnetic composition is iron, cobalt or nickel, the metallic glass forming composition is phosphorus, boron, molybdenum, niobium, zirconium silicon, or carbon, the master alloy block material is smelted from iron, cobalt or nickel (one or more compositions) and phosphorus, boron, silicon, carbon, niobium, zirconium or molybdenum (one or more compositions).

3. The method mentioned of claim 1, wherein the additive manufacturing device contains a work unit and a thermal management unit, the work unit provides the beam power and the beam melting time to melt, cool and condense the working powder, and during melting, cooling and condensing the working powder, the thermal management unit controls the beam power and the beam melting time provided by the work unit.

4. The method of claim 3, wherein the thermal management unit contains a special water cooling platform and a real-time temperature monitoring feedback module, the real-time temperature monitoring feedback module sends messages to the work unit and the special water cooling platform, to adjust the beam power and the beam melting time provided by the work unit, and the special water cooling platform controls the cooling and condensation rate of the working powder.

5. The method of claim 1, wherein, during melting the master alloy block material and exerting a force on it, if the force is a fluid impact force, the molten master alloy block material are cut into the liquid microspheres by the fluid impact force, and the liquid microspheres form the coarse powder by cooling and condensation.

6. The method of claim 1, wherein, during melting the master alloy block material and exerting a force on it, if the force is a rotating centrifugal force, the molten master alloy block material is dispersed and aggregated into the liquid microspheres by the rotating centrifugal force, and the liquid microspheres form the coarse powder by cooling and condensation.

7. The method of claim 1, wherein, during screening the coarse powder, the fine powder with a variety of particle size ranges is gradually separated from the coarse powder by the centrifugal force, and the fine powder (at least including two particle size ranges) is mixed into the working powder.

8. The method of claim 1, wherein, if using the laser additive manufacturing device, the particle size range of the working powder is 15 to 45 microns.

9. The method of claim 1, wherein, if using the electron beam additive manufacturing device, the particle size range of the working powder is 45 to 105 microns.

10. The method of claim 1, wherein the soft magnetic material has a non-crystalline and non-directional structure.
